(19) United States
(12) Patent Application Publication
(10) Pub. No.: US 2006/0158525 A1
(43) Pub. Date: Jul. 20, 2006

(54) Photo protection device and method

(76) Inventor: Gilbert W. Skillman, Kannapolis, NC (US)

Correspondence Address: ADAMS EVANS P.A., 2180 TWO WACHOVIA CENTER, CHARLOTTE, NC, 28282, US

(21) Appl. No.: 11/091,162

(22) Filed: Mar. 28, 2005

Related U.S. Application Data
(60) Provisional application No. 60/644,171, filed on Jan. 14, 2005.

(51) Int. Cl. H04N 5/232; H04N 5/76; H04N 9/04

(52) U.S. Cl. 348/211.2; 348/231.99

(57) ABSTRACT

A photo protection device for discouraging a would-be attacker or burglar. The protection device includes a camera, a wireless transmitter connected to the camera, and an actuator. The actuator is operably connected to the camera and the wireless transmitter. The actuator causes the camera to take a photo or video and the wireless transmitter to transmit the photo or video.

### TECHNICAL FIELD AND BACKGROUND OF THE INVENTION

This application claims the benefit of Provisional Application No. 60/644,171 filed on Jan. 14, 2005.

This invention relates to deterrent-type protection devices and more specifically to a photo protection device for discouraging a would-be attacker or burglar.

Currently there are many types of personal and property protection devices on the market. For example, an individual can carry a pepper spray dispenser or other similar devices to ward off a would-be attacker. While such devices are very effective in many circumstances, they do not necessarily deter would-be attackers or aid the police in finding the attacker and preventing repeat attacks.

Security systems are often installed in homes or businesses to monitor the premises for fire, unauthorized entry, etc. Typically, the security system is hardwired to a building power supply. Additionally, the system may be connected to the security company's monitoring station via the local telephone system or other hardwired connection. As a result, a loss of power or the monitoring connection due to a power outage, sabotage, or vandalism could disable the security system and negate any protection that is provided, allowing a burglar to enter the premises undetected.

Accordingly, there is a need for a deterrent-type protection system that can be used by individuals and businesses alike which overcomes the disadvantages of current protection devices.

### SUMMARY OF THE INVENTION

Therefore, it is an object of the invention to provide a photo protection device that is immune to power failures.

It is another object of the invention to provide a photo protection device that can transmit a photo or video to a specified location immediately after being taken.

It is another object of the invention to provide a photo protection device that can be carried on a person.

These and other objects of the present invention are achieved in the preferred embodiments disclosed below by providing a protection device including a camera, a wireless transmitter operably connected to the camera, and an actuator. The actuator is operably connected to the camera and the wireless transmitter. The actuator causes the camera to take a photo or video and the wireless transmitter to transmit the photo or video in response to a single triggering action.

According to another preferred embodiment of the invention, the protection device further includes a storage device for storing the photo or video.

According to another preferred embodiment of the invention, the protection device further includes a self-contained power supply for allowing the protection device to be portable.

According to another preferred embodiment of the invention, the wireless transmitter further transmits data including location of the protection device and time when the photo or video was transmitted.

According to another preferred embodiment of the invention, the protection device is a modified camera phone.

According to another preferred embodiment of the invention, the actuator is a panic button.

According to another preferred embodiment of the invention, the actuator is a sensor selected from the group consisting of motion and heat sensors.

According to another preferred embodiment of the invention, the wireless transmitter transmits the photo or video by a wireless service selected from the group consisting of text messaging, wireless internet, wireless phone service, radio frequency (RF) band, and direct-connect.

According to another preferred embodiment of the invention, a deterrent-type protection device includes a phone; a camera positioned on the phone for taking a photo or a video; a wireless transmitter positioned within the phone for transmitting the photo or video; and a panic button positioned on the phone. The panic button is operably connected to the camera and the wireless transmitter. The panic button causes the camera to take the photo or video and the wireless transmitter to transmit the photo or video to a specified location in response to a single activation of the panic button.

According to another preferred embodiment of the invention, a method of providing protection includes the steps of providing a protection device having a camera, an actuator, and a wireless transmitter; pointing the camera at a designated target; and triggering the actuator. Triggering the actuator causes the camera to take a photo or video of the designated target and the wireless transmitter to transmit the photo or video to a specified location.

According to another preferred embodiment of the invention, the method further includes the step of receiving the photo or video at the location.

According to another preferred embodiment of the invention, the method further includes the step of time stamping a time of receipt on the photo or video and storing the photo or video in a database for a specified period of time.

According to another preferred embodiment of the invention, the specified location is a repository.

### BRIEF DESCRIPTION OF THE DRAWINGS

The invention may be best understood by reference to the following description taken in conjunction with the accompanying drawings, in which:

FIG. 1 is a front elevation of a photo protection device according to an embodiment of the invention;

FIG. 2 is a side elevation of the photo protection device of FIG. 1;

FIG. 3 shows an individual taking a photo of an attacker and transmitting the photo to a repository;

FIG. 4 is a front elevation of a photo protection device according to another embodiment of the invention;

FIG. 5 is a side elevation of the photo protection device of FIG. 4; and

FIG. 6 shows a photo protection device according to another embodiment of the invention taking a photo of a burglar and transmitting the photo to a repository.

### DESCRIPTION OF THE PREFERRED EMBODIMENT AND BEST MODE

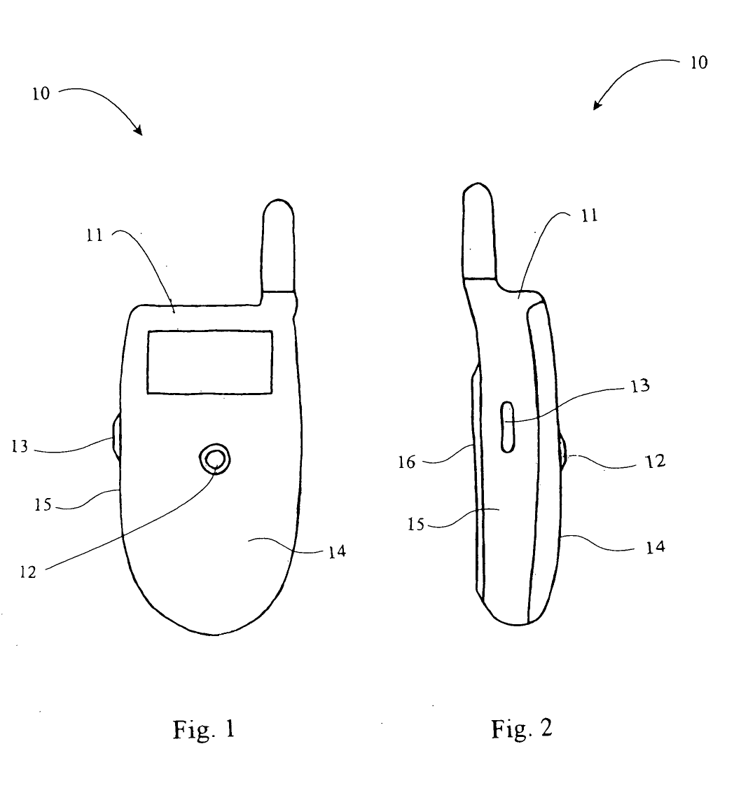

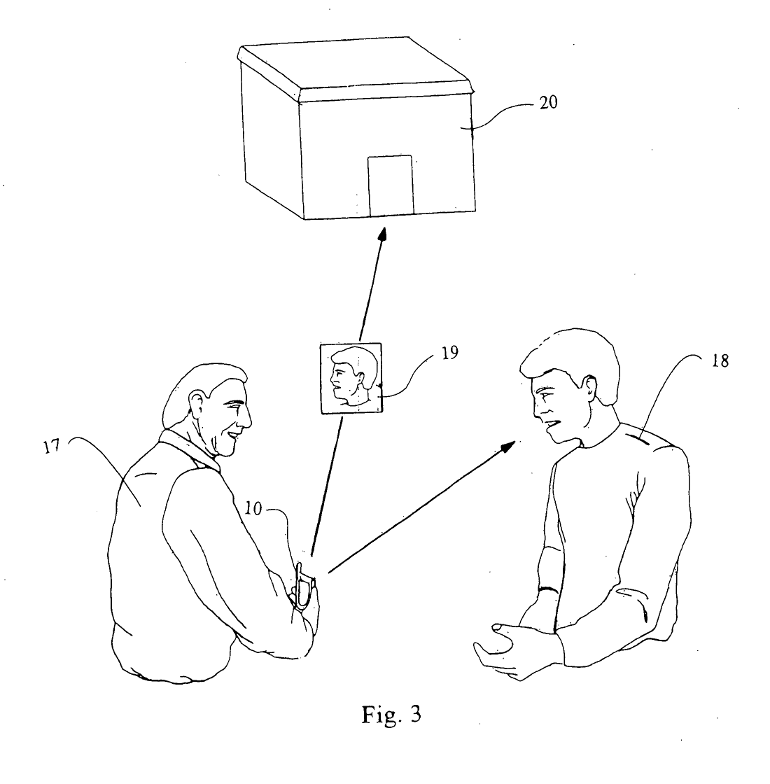

Referring now specifically to the drawings, a photo protection device according to an embodiment of the present invention is illustrated in FIGS. 1 and 2 and shown generally at reference numeral 10. The basic components of the photo protection device 10 are a camera 12, an actuator such as a panic button 13, a wireless transmitter (not shown), a storage device (not shown), and a power supply 16. In this embodiment, the photo protection device 10 is a modified camera-equipped cellular phone or “camera phone” 11. The camera 12 is positioned on a front panel 14 of the phone 11 and the panic button 13 is positioned on a side panel 15. It should be appreciated that the phone 11, as shown, is for illustrative purposes only and any style or type of cellular phone may be used in the present invention. It should also be appreciated that the camera 12 and panic button 13 may be positioned in various locations, depending on the type of phone or needs of an individual.

In the prior art, to take a photo or video and transmit it with a cellular phone, the user must go through a set of menu options, then aim the camera and take the photo or video. The user must then save the photo or video into a directory on the phone and then dial a number where the photo or video is to be transmitted.

The photo protection device 10 eliminates the need to perform the steps above by operably connecting the panic button 13 to the camera 12 and the wireless transmitter within the phone 11 to allow one-touch photo or video taking and one-touch transmitting. Depressing the button 13 causes the camera 12 to take a photo or video, depending on the preference of the user. The steps involved are the same for both the photo option and the video option, thus only the photo option will be discussed. The photo is then automatically stored in the phone 11 by the storage device. The wireless transmitter transmits the photo to a specified location as soon as the camera 12 takes the photo. Thus, there is no need to dial a phone number or save the photo to the phone 11 before transmitting the photo. This process may be enabled through suitable programming of the cellular phone 11. The wireless transmitter can transmit the photo by wireless services such as text messaging, wireless internet, or standard wireless phone service, or the transmitter can broadcast in the radio frequency (RF) band or utilize a direct-connect system such as that found on a walkie-talkie type wireless phone.

By immediately transmitting the photo as described above, the probability of the attacker destroying or stealing the phone 11, or deleting the picture before his photo has been transmitted to the proper authorities is eliminated.

The wireless transmitter may also transmit the location of the photo protection device when the photo was taken. This can be done through technology such as Assisted GPS (AGPS). When the photo is taken, the wireless transmitter would transmit the photo, the location where the photo was taken, and the time the photo was taken. This would assist law enforcement in pinpointing when, where, and who made the attack. For example, if a person is abducted in a city, the police could access all photos that were transmitted during the week or day of the abduction from that city.

As shown in FIG. 3, an individual 17 carries the photo protection device 10 on his person. When the individual 17 suspects that he is about to be attacked or becomes fearful of an attack, the individual 17 points the camera 12 at the suspected attacker 18 and depresses the button 13, taking a photo 19 of the suspected attacker 18. The photo 19 and any other information such as location and time of transmission is then immediately transmitted by the wireless transmitter to a specified location such as a repository 20 for safe keeping. The repository 20 receives the transmission, time stamps the time of receipt, and stores the information in a database for a specified period of time before deleting the information from its database. The information becomes the property of the repository 20 and is maintained in confidence to protect the suspected attacker 18 in the event that the photo 19 was taken by mistake. The information would generally be accessible by authorized persons, such as police officers or the like, but in some cases may only be accessible by a subpoena. Once authorization to access the information has been granted, the information may be shared locally, nationally, and internationally.

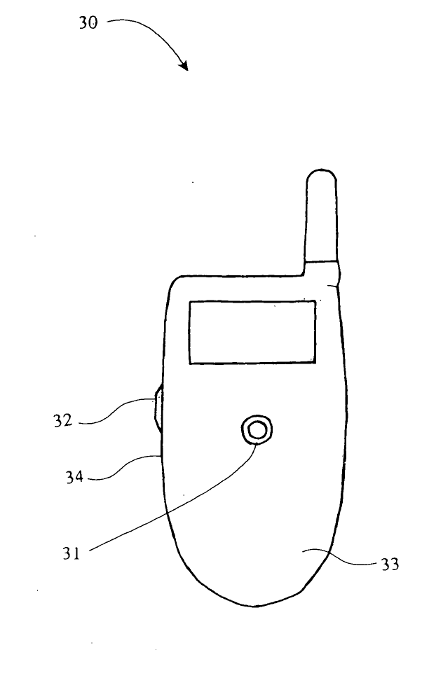

An alternative photo protection device 30 is shown in FIGS. 4 and 5. Like the photo protection device 10, photo protection device 30 has a camera 31 positioned on a front panel 33 and an actuator such as a panic button 32 positioned on a side panel 34. The photo protection device 30 also includes a self contained power supply 35, a wireless transmitter (not shown), and a storage device (not shown). It should be appreciated that the photo protection device 30, as shown, is for illustrative purposes only and any style, shape, or size may be used in the present invention. Examples include a wrist watch, a phone, and a pen.

The photo protection device 30 is not required to receive or place calls and is only required to take a single photo and immediately transmit the photo via the wireless transmitter to a specified location and store the photo as described above. As described above, the wireless transmitter may also transmit the location where the photo was taken as well as the time. The advantage of photo protection device 30 is that it is an inexpensive device that could be purchased by parents and given to their children to use as a deterrent-type protection device. Thus, if an attacker destroyed or stole the photo protection device 30 or the child lost the photo protection device 30, the loss to the owner would be minimal.

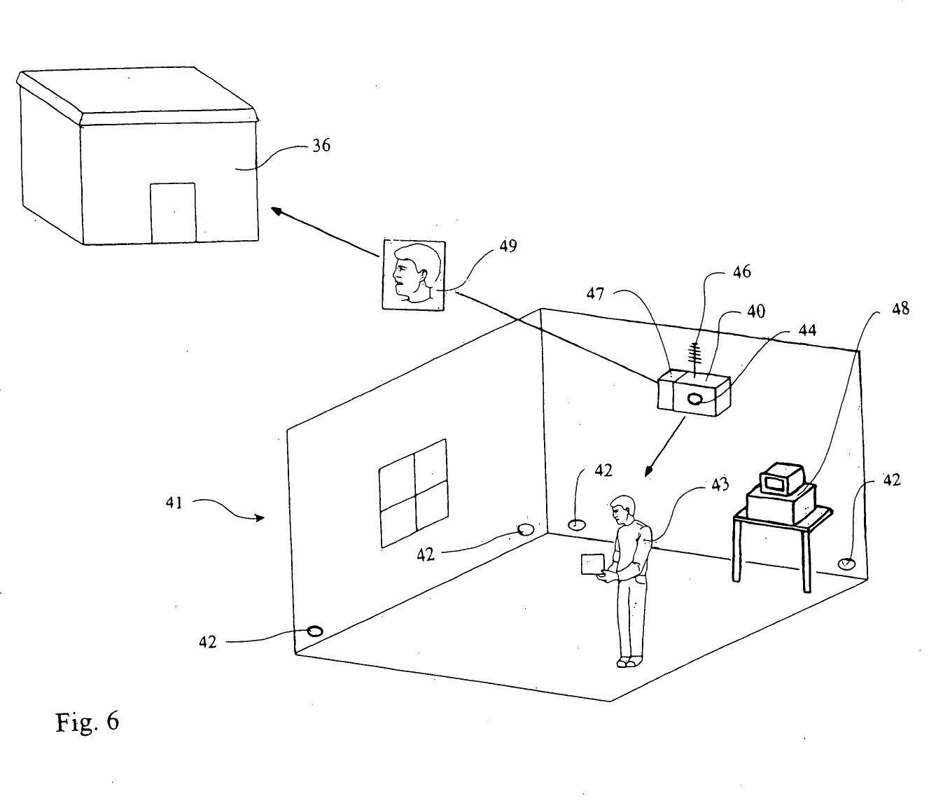

In another embodiment of the invention shown in FIG. 6, a self-powered, wireless photo protection device 40 is installed in a building 41 such as a residence, business, or the like, and connected to sensors 42, such as motion or heat sensors, which act as an actuator, and would be tripped in the event that a burglar 43 would enter the premises. The photo protection device 40 includes a camera 44, a wireless transmitter 46, a self-contained power supply 47, such as a solar panel or battery, and a storage device 48. The photo protection device may be a high quality camera security system linked to a wireless connection for transmitting a photo or may be one or more photo protection devices similar to the photo protection device 30 linked to the plurality of sensors 42. The sensors 42 would be located in various positions to detect movement or the breaking of a door or window, and once the sensors 42 have been tripped, the photo detection device 40 takes a photo 49 of the burglar 43 and then immediately transmits the photo 49 and any associated information, as described above with reference to the photo protection device 10, to a specified place such as a repository 46. The transmitted photo 49 may also be transmitted to a security company, or other specified location. The photo 49 is also stored by the storage device 48 for later retrieval by the owner, police, or other authorized person.

The photo protection device 40 is self powered and transmits via a wireless communication, preventing the system from being tampered with by a burglar by cutting the power to the building or cutting any hardwired transmission lines that are used to alert a security company. Thus, the system is immune to power failures that are caused by storms, outages, or other disasters.

The photo protection devices in each of the above embodiments may be registered with a repository, security company, or the like using a serial number. The serial number would be transmitted with the photo, location, and time to a specified location to identify the owner of the photo protection device, aiding law enforcement in identifying the individual who took the photo.

A photo protection device is described above. Various details of the invention may be changed without departing from its scope. Furthermore, the foregoing description of the preferred embodiment of the invention and the best mode of practicing the invention are provided for the purpose of illustration only and not for the purpose of limitation.

I claim:

1. A protection device, comprising:
(a) a camera;
(b) a wireless transmitter operably connected to the camera; and
(c) an actuator operably connected to the camera and the wireless transmitter, wherein the actuator causes the camera to take a photo or video and the wireless transmitter to transmit the photo or video in response to a single triggering action.

2. The protection device according to claim 1, and further including a storage device for storing the photo or video.

3. The protection device according to claim 1, and further including a self-contained power supply for allowing the protection device to be portable.

4. The protection device according to claim 1, wherein the wireless transmitter further transmits data including location of the protection device and time when the photo or video was transmitted.

5. The protection device according to claim 1, wherein the protection device is a modified camera phone.

6. The protection device according to claim 1, wherein the actuator is a panic button.

7. The protection device according to claim 1, wherein the actuator is a sensor selected from the group consisting of motion and heat sensors.

8. The protection device according to claim 1, wherein the wireless transmitter transmits the photo or video by a wireless service selected from the group consisting of text messaging, wireless internet, wireless phone service, radio frequency (RF) band, and direct-connect.

9. A deterrent-type protection device, comprising:
(a) a phone;
(b) a camera positioned on the phone for taking a photo or a video;
(c) a wireless transmitter positioned within the phone for transmitting the photo or video; and
(d) a panic button positioned on the phone, wherein the panic button is operably connected to the camera and the wireless transmitter for causing the camera to take the photo or video and the wireless transmitter to transmit the photo or video to a specified location in response to a single activation of the panic button.

10. The deterrent-type protection device according to claim 9, and further including a storage device for storing the photo or video.

11. The deterrent-type protection device according to claim 9, and further including a self-contained power supply for allowing the protection device to be portable.

12. The deterrent-type protection device according to claim 9, wherein the wireless transmitter further transmits data including location of the protection device and time when the photo or video was transmitted.

13. The protection device according to claim 9, wherein the wireless transmitter transmits the photo or video by a wireless service selected from the group consisting of text messaging, wireless internet, wireless phone service, radio frequency (RF) band, and direct-connect.

14. A method of providing protection, comprising the steps of:
(a) providing a protection device having a camera, an actuator, and a wireless transmitter;
(b) pointing the camera at a designated target; and
(c) triggering the actuator, wherein triggering the actuator causes the camera to take a photo or video of the designated target and the wireless transmitter to transmit the photo or video to a specified location.

15. The method according to claim 14, and further including the step of receiving the photo or video at the location.

16. The method according to claim 15, and further including the step of time stamping a time of receipt on the photo or video and storing the photo or video in a database for a specified period of time.

17. The method according to claim 14, and further including the step of registering a serial number of the protection device with the specified location for identifying the owner of the protection device when the photo or video is taken and transmitted.

18. The method according to claim 14, wherein the specified location is a repository.

19. The method according to claim 14, wherein the actuator is a panic button.

20. The method according to claim 14, wherein the actuator is a sensor selected from the group consisting of motion and heat sensors.
